(19) United States
(12) Patent Application Publication
(10) Pub. No.: US 2026/0091804 A1
(43) Pub. Date: Apr. 2, 2026

(54) SELF-LEARNING FROM AIR OF ARTIFICIAL INTELLIGENCE MODELS APPLICABLE FOR DRIVING

(71) Applicant: AUTOBRAINS TECHNOLOGIES LTD, Tel Aviv-Yafo (IL)

(72) Inventors: Igal RAICHELGAUZ, Tel Aviv (IL); Ido COHEN, Tel Aviv-Yafo (IL)

(73) Assignee: AUTOBRAINS TECHNOLOGIES LTD, Tel Aviv-Yafo (IL)

(21) Appl. No.: 18/902,984

(22) Filed: Oct. 1, 2024

(51) Int. Cl. B60W 60/00; G06V 10/82; G06V 20/10

(52) U.S. Cl. CPC B60W 60/001; G06V 10/82; G06V 20/10; B60W 2556/45

(57) ABSTRACT

A method of self-learning from air of AI models applicable for driving, the method includes obtaining, by a computerized system, aerial image signatures of patches of aerial images that capture at least parts of an environment faced by a vehicle, wherein the computerized system is associated with a set of artificial intelligence models applicable for autonomous driving; identifying, from the aerial image signatures, a set of aerial image signatures in accordance with a specified driving scenario faced by the vehicle; and training, in a self-supervised learning process based, at least in part, on the identifying, a neural network implementing an artificial intelligent model to provide a decision making for the specified driving scenario, wherein the artificial intelligence model is at least one of: a new artificial intelligence model, or one of the set of artificial intelligence models associated with the computerized system.

### BACKGROUND

Vehicles include machine learning processes are trained using ground vehicle images that are of limited value in some cases.

There is a growing need to improve driving related capabilities of the vehicles.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a computerized system;

FIG. 3 illustrates an example of a vehicle;

FIG. 3 illustrates an example of a method; and

FIG. 4 illustrates an example of a method.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

The term obtaining include receiving and/or generating.

According to an embodiment a scenario includes at least one of (a) a location of the vehicle, (b) one or more weather conditions, (c) one or more contextual parameters, (d) a road condition, (e) a traffic parameter. Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information-context may be depending on or relating to the circumstances that form the setting for an event, statement, or idea.

According to an embodiment, there is provided a method of self-learning from air of AI models applicable for driving, the method includes:
Obtaining, by a computerized system, aerial image signatures of patches of aerial images that capture at least parts of an environment faced by a vehicle, wherein the computerized system is associated with a set of artificial intelligence models applicable for autonomous driving.
Determining whether any of the set of artificial intelligence models is within a confidence level to provide the decision making for the specified driving scenario, such that the training is in accordance with the determining.
Training, based on the determining in a self-supervised learning process, a neural network for implementing the determined artificial intelligence model using at least a portion of the aerial image signatures, such that the training is for the specified driving scenario, and the determined artificial intelligence model is at least one of the set of artificial intelligence models, or a new artificial intelligence model.

According to an embodiment the method is executed offline by a computerized system and is based on aerial images-which are not dependent on ground vehicle sensors and may provide, in some cases, more accurate information-for example may provide a more accurate distance estimate and/or may cover a larger region that the coverage provided by ground vehicle sensors, and/or allow a better prediction of road users especially when the road users are initially out of sight of the vehicle, and the like.

According to an embodiment, the usage of aerial images enables to understand or predict the expected behavior—for example of road objects in the scenario (e.g. parking lot; specific neighborhood)—for selection and activation of relevant artificial intelligent models that are trained for that particular behavior.

According to an embodiment, the usage of aerial images enables to predict more accurately the next relevant artificial intelligence models for activation.

According to an embodiment, the usage of aerial images enables to narrow down the next set of artificial intelligence models for downloading, and activation in the near, or upcoming future-bringing (i.e. preparing to a more complete downloading) more (the most) relevant artificial intelligence models agents to a cache—most relevant to occurrence in a parking lot/pedestrian street/particular neighborhood—(i.e. not bringing irrelevant, or less relevant artificial intelligence models).

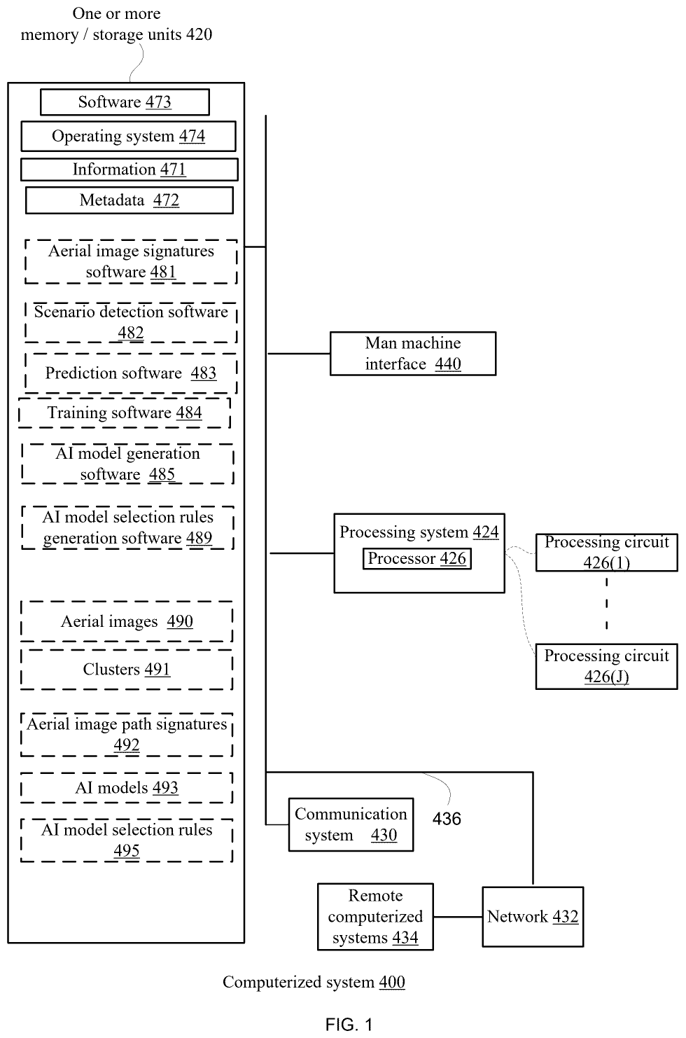

FIG. 1 illustrates an example of a computerized system 400.

Computerized system 400 includes a man machine interface 440 having or being in communication with man machine interface (MMI) controller (not shown), a communication system 430, one or more memory and/or storage units 420, a processing system 424 including processor 426. The computerized system may be a server, a laptop, a desktop or any other computer and may include or be in communication with a sensing unit and/or a controller.

According to an embodiment, computerized system 400 is in communication with network 432 and one or more other remote computerized systems 434 that are in communication with network 432. An example of a remote computerized system is a vehicle (such as vehicle 300 of FIG. 2), a server or one or more computers having access to a storage system.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as man machine interface 440.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example-any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the computerized system and is used for communication between the computerized system and at least one remote computing system and/or one or more vehicles. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the computerized system. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of: operating system 474, information 471, metadata 472, and software 473.

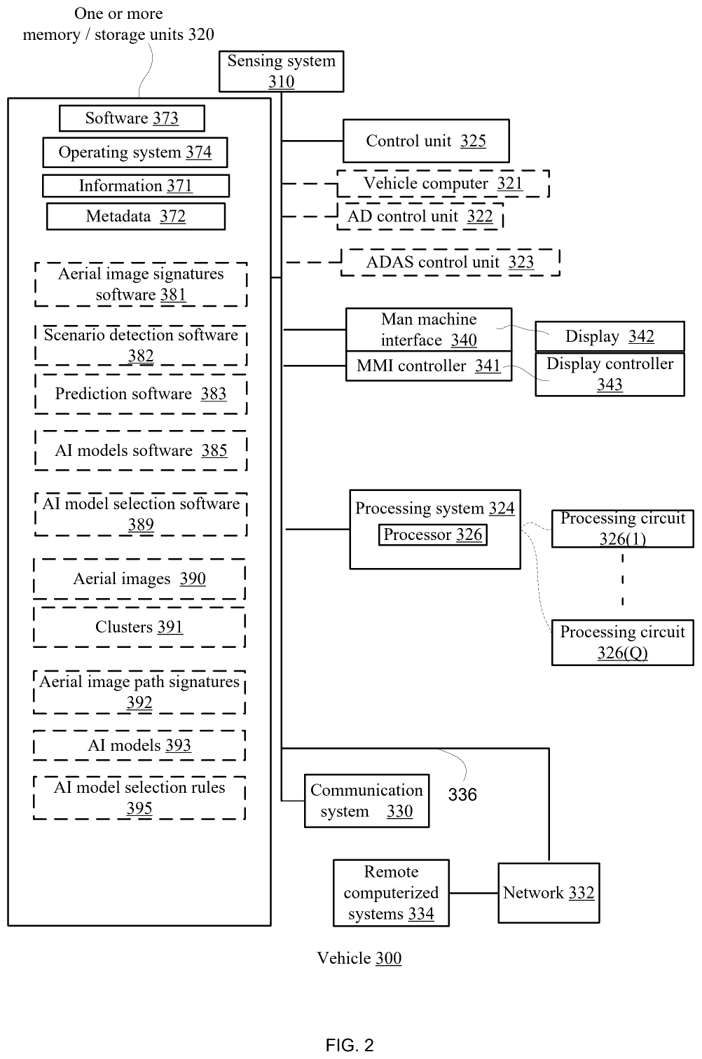

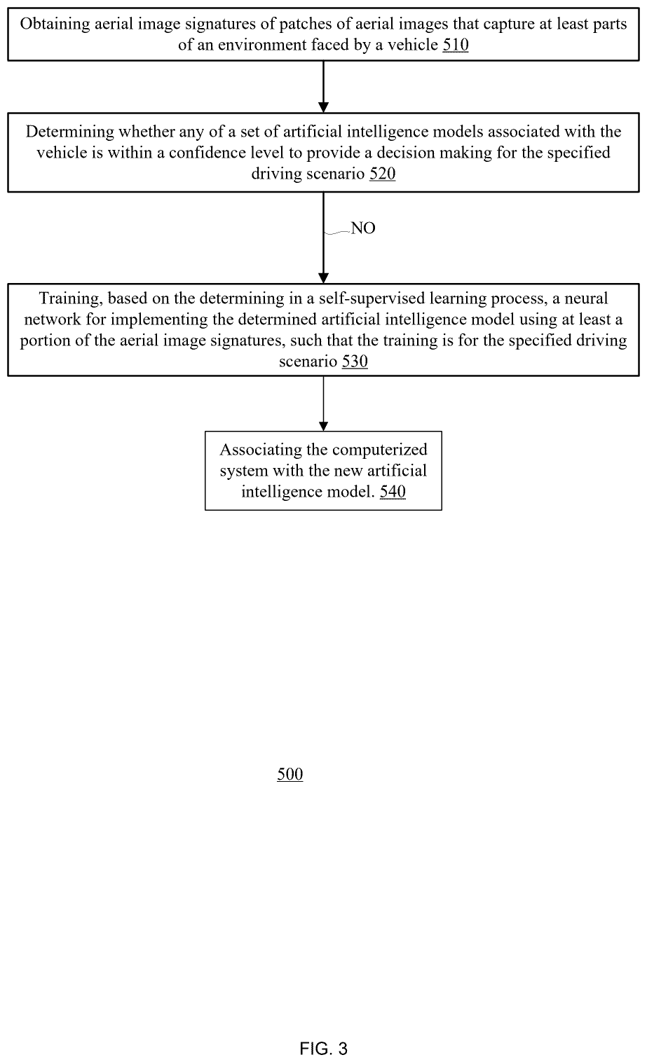

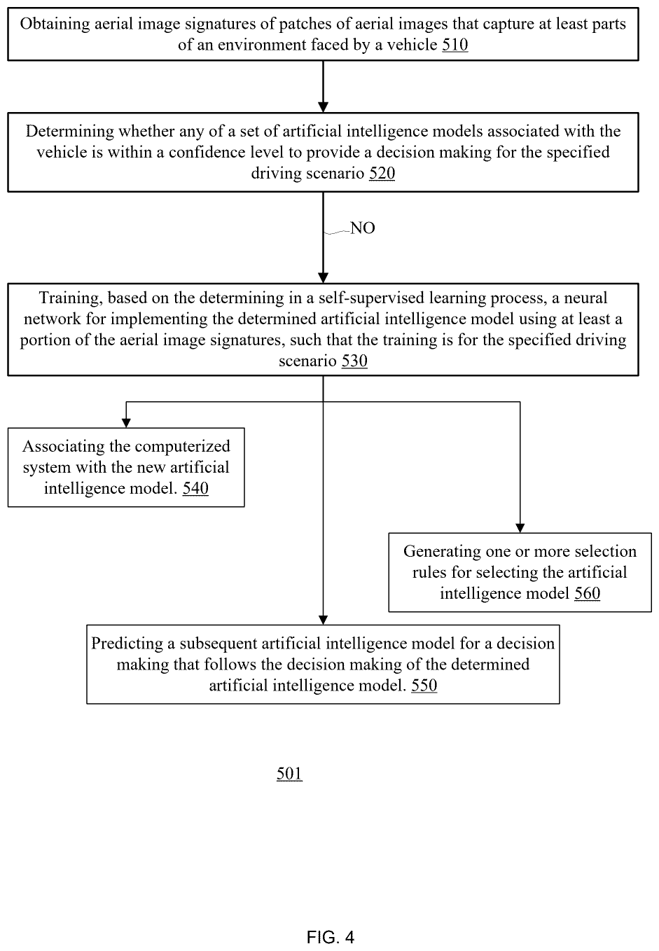

Examples of software include at least one of aerial image signature software 481 (used for obtaining the aerial images—for example during step 510 of FIG. 3), scenario detection software 482 (used for determining a scenario and/or during step 530 of FIG. 3 in which an artificial intelligence model is trained in associated with a new scenario), prediction software 483 (used for prediction—for example during step 550 of FIG. 4), training software 484 (used for training—for example during step 530 of FIG. 3), artificial intelligence (AI) model generation software 485 (used for generating the AI models—for example by the training of step 530 of FIG. 3) and AI module selection rules generation software 489 (used for generating AI model selection rules—for example during step 560 of FIG. 4), Only one or some of these software may be stored in the one or more memory/storage units 420.

Examples of information and/or metadata include at least one of aerial images 490, clusters 491 of signatures and/or clusters of sensed information associated with the signatures the sensed information include aerial images but may include additional information, aerial images patch signatures 492, AI models 493, and AI model selection rules 495. Only one or some of these information and/or metadata may be stored in the one or more memory/storage units 420.

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 is configured to perform method 600 while executing software.

According to an embodiment, processing system 424 is configured to perform at least one of the following when executing software:
Obtain, by a computerized system, aerial image signatures of patches of aerial images that capture at least parts of an environment faced by a vehicle, wherein the computerized system is associated with a set of artificial intelligence models applicable for autonomous driving.
Determine whether any of the set of artificial intelligence models is within a confidence level to provide the decision making for the specified driving scenario, such that the training is in accordance with the determining.
Train, based on the determining in a self-supervised learning process, a neural network for implementing the determined artificial intelligence model using at least a portion of the aerial image signatures, such that the training is for the specified driving scenario, and the determined artificial intelligence model is at least one of the set of artificial intelligence models, or a new artificial intelligence model
Associate the computerized system with the new artificial intelligence model
Predict a subsequent artificial intelligence model for a decision making that follows the decision making of the determined artificial intelligence model.

FIG. 2 illustrates an example of vehicle 300 configured to utilize the set of artificial intelligence models during inference.

Vehicle 300 includes a man machine interface 340 having or being in communication with man machine interface (MMI) controller 341, wherein in FIG. 1 the MMI is a display 342 or includes a display 342 and the MMI controller is a display controller 343 or includes the display controller 343, a communication system 330, one or more memory and/or storage units 320, a processing system 324 including processor 326. The communication system 330, the one or more memory and/or storage units 320, and the processing system 324 may belong to a computerized system of vehicle 300. The computerized system may be a server, a laptop, a desktop or any other computer and may include or be in communication with a sensing unit and/or a controller.

According to an embodiment, vehicle 300 is in communication with network 332 and one or more other remote computerized systems 334 that are in communication with network 332. An example of a remote computerized system is a server or one or more computers having access to a storage system that stores items related to one or more portions of one or more groups of neural networks—at least some of which are not currently stored in the vehicle.

According to an embodiment, the communication system 330 is configured to enable communication between the one or more memory and/or storage units 320 and/or any one of the additional units and/or the network 332 (that is in communication with the remote computerized systems). Communication system 330 is also configured to enable communication with other elements such as sensing system 310, man machine interface 340, control unit 325, vehicle computer 321, autonomous driving control unit 322 (denoted AD control unit), advanced driver assistance system (ADAS) control unit 323 (denoted ADAS control unit), and the like.

The memory and/or storage units 320 was shown as storing software. Any reference to software should be applied mutatis mutandis to code and/or firmware and/or instructions and/or commands, and the like.

Processor 326 includes a plurality of processing units 326(1)-326(Q), Q is an integer that exceeds one. Any reference to one unit or item should be applied mutatis mutandis to multiple units or items. For example—any reference to processor should be applied mutatis mutandis to multiple processors, any reference to communication system 330 should be applied mutatis mutandis to multiple communication systems.

According to an embodiment, the one or more memory and/or storage units 320 includes one or more memory unit, each memory unit may include one or more memory banks.

Any reference to memory and/or storage units 420 should be applied mutatis mutandis to one or more memory and/or storage units 320.

Any reference to communication system 430 should be applied mutatis mutandis to communication system 330.

Any reference to bus 436 should be applied mutatis mutandis to bus 336.

Any reference to network 432 should be applied mutatis mutandis to network 332.

According to an embodiment, the memory and/or storage units3 20 stores at least one of: operating system 374, information 371, metadata 372, and software 373.

Examples of software include at least one of aerial image signature software 381 for obtaining the aerial image signatures during inference, scenario detection software 382 for detecting scenarios during inference, prediction software 383 for predicting the next AI models during inference, artificial intelligence (AI) models software 385 for implementing the AI models, and AI module selection software 389. Only one or some of these software may be stored in the one or more memory/storage units 320.

Examples of information and/or metadata include at least one of aerial images 390, clusters 391 of signatures and/or clusters of sensed information associated with the signatures the sensed information include aerial images but may include additional information, aerial images patch signatures 392, AI models 393, and AI model selection rules 395. Only one or some of these information and/or metadata may be stored in the one or more memory/storage units 320.

The control unit 325 may cooperate with ADAS control unit 323 and/or with AD control unit 322 and/or may control or communicate with other vehicle components—including vehicle computer.

The ADAS control unit 323 is configured to control ADAS operations.

The AD control unit 322 is configured to control autonomous driving of the autonomous vehicle.

The vehicle computer 321 is configured to control the operation of the vehicle-especially controlling the engine, the transmission, and any other vehicle system or component.

The vehicle computer 321 may be in communication with an engine control module, a transmission control module, a powertrain control module, and the like.

The sensing system 310 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 310 is configured to output one or more sensed information units (SIUs).

Control unit 325 is configured to control the operation of the sensing system 310, and/or the one or more memory and/or storage units 320 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 330. Other communication elements may be provided.

According to an embodiment, processing system 324 is configured to perform method 600, while executing software.

According to an embodiment, processing system 324 is configured to perform, while executing software:
Obtain aerial image signatures of patches of aerial images.
Determine, based on the aerial image signatures a scenario faced by the vehicle;
Select, for example by a perception router, out of a set of artificial intelligence models, one or more selected artificial intelligence models;
Generate, by the one or more selected artificial intelligence models, one or more one or more selected artificial intelligence models decisions;
Generate or trigger a generation of a driving related output, based on the one or more selected artificial intelligence models decisions.

FIG. 3 illustrates an example of method 500 for generating artificial intelligence models for driving related scenarios. FIG. 4 illustrates an example of method 501 for generating artificial intelligence models for driving related scenarios. Method 501 of FIG. 4 differs from method 500 of FIG. 3 by including steps 550 and 560.

According to an embodiment, method 500 starts by step 510 of obtaining, by a computerized system, aerial image signatures of patches of aerial images that capture at least parts of an environment faced by a vehicle, wherein the computerized system is associated with a set of artificial intelligence models applicable for autonomous driving.

An example of generation of aerial image signatures is illustrated in U.S. patent application Ser. No. 18/527,701 which is incorporated herein by reference.

According to an embodiment, step 510 includes receiving the aerial image signatures of patches of aerial images.

According to an embodiment, step 510 includes receiving the aerial images and generating the aerial image signatures of the patches of aerial images.

According to an embodiment, step 510 includes generating (sensing) the aerial images and generating the aerial image signatures of the patches of aerial images.

According to an embodiment the aerial images are captured by one or more aerial sensors located at one of more heights—such as but not limited to outside the atmosphere, within the atmosphere, at a height of one or more kilometers, at a height of one or more meters, by a satellite, by an airplane, by a drone, by an, unmanned airborne vehicle, and the like.

According to an embodiment the image is a visual image, a radar image, a sonar image, a thermal image, an ultrasound image, an x-ray image, a near infrared image, and the like.

According to an embodiment, step 510 includes downloading the aerial image signatures at different points in time, in accordance with the driving scenario faced by the vehicle.

According to an embodiment, step 510 includes obtaining the aerial image signatures in accordance with the specified driving scenario.

According to an embodiment, step 510 is followed by step 520 of determining whether any of the set of artificial intelligence models is within a confidence level to provide the decision making for the specified driving scenario, such that the training is in accordance with the determining.

According to an embodiment, step 520 includes identifying a matching between the identified set of aerial image signatures and a corresponding set of signatures in association with any of the set of artificial intelligence models.

According to an embodiment step 520 is based on a maturity of any of the of the set of artificial intelligence models to perform the decision making process with respect to the specified driving scenario.

According to an embodiment, when determining that the set of artificial intelligence models does not include any artificial intelligence model that is within the confidence level step 520 is followed by step 530 of training, based on the determining in a self-supervised learning process, a neural network for implementing the determined artificial intelligence model using at least a portion of the aerial image signatures, such that the training is for the specified driving scenario, and the determined artificial intelligence model is at least one of the set of artificial intelligence models, or a new artificial intelligence model.

According to an embodiment, the determined artificial intelligence model is a new artificial intelligence model, and step 530 is followed by step 540 of associating the computerized system with the new artificial intelligence model.

According to an embodiment, method 501 further includes step 550 of predicting a subsequent artificial intelligence model for a decision making that follows the decision making of the determined artificial intelligence model.

According to an embodiment, method 501 further includes step 560 of generating one or more selection rules for selecting the new artificial intelligence model during inference and when a vehicle faces the specified driving scenario.

According to an embodiment, the instructions involve triggering a responsive action with respect to the set of artificial intelligence models, based on the identifying and by using the aerial image signatures.

According to an embodiment, step 530 trains the artificial intelligence model to trigger a notification indication to an autonomous driving application of the vehicle.

According to an embodiment at least one of the set of artificial intelligence modules are trained to respond only to aerial image related information and/or metadata (such as aerial related signatures).

According to an embodiment at least one of the set of artificial intelligence modules are trained to respond to a combination to ground vehicles sensed information and/or metadata and to aerial image related information and/or metadata (such as aerial related signatures).

According to an embodiment, the different artificial intelligence models of the set of artificial intelligence models are configured to generate decisions that are driving related outputs or are configured to generate artificial intelligence model decisions that are further processed (for example by a unit or module that follows the set) that provide the driving related decisions. An example of a unit or module that follows the set and generates the driving related output is a driving decision unit—such as the driving decision unit of PCT patent application Ser. No. 18/459,414 titled “perception based driving” which is incorporated herein by reference.

According to an embodiment, the driving related output includes at least one of:
An instruction executable by a man machine interface controller, to provide a recommendation to a driver regarding a navigation of the vehicle.
A request aimed to the man machine interface controller, to provide a recommendation to a driver regarding a navigation of the vehicle.
An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
An instruction executable by a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
A request aimed to a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
An instruction executable by a computer vehicle related to a manner of operation of any component of the vehicle such as brakes, engine, and the like.
A request sent to a computer vehicle related to a manner of operation of any component of the vehicle such as brakes, engine, and the like.
Information about the environment of the vehicle.
A prediction of a future path of the vehicle.
A prediction of a behavior of one or more road element.
An emergency alert.
A collision alert.

According to an embodiment, during inference, the generation of a driving related output is followed by outputting and/or transmitting an/or storing and/or instructing to respond to and/or triggering a response to and/or controlling a response to and/or performing a respond to any of the driving related outputs listed above and/or below.

According to an embodiment, during inference, the generation of a driving related output is followed by generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment—and/or in the environment with re to the vehicle, an operation and/or response in compliant with one or more levels of autonomous driving—such as L2, L2+, L2++, L3 or L4 autonomous driving.

According to an embodiment, during inference, the generation of a driving related output includes storing the driving related output at a location accessible to another unit controller, transmitting instructions of the driving related output to the other unit, sending an indication about the generation of the instructions of the driving related output to the other unit man machine interface controller.

According to an embodiment, during inference, the generation of a driving related output is followed by outputting and/or transmitting an/or storing and/or instructing to respond to and/or triggering a response to and/or controlling a response to and/or performing a respond to any of the driving related output listed above and/or below.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove.

Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim:

1. A method of self-learning from air of AI models applicable for driving, comprising:
obtaining, by a computerized system, aerial image signatures of patches of aerial images that capture at least parts of an environment faced by a vehicle, wherein the computerized system is associated with a set of artificial intelligence models applicable for autonomous driving;
identifying, from the aerial image signatures, a set of aerial image signatures in accordance with a specified driving scenario faced by the vehicle; and
training, in a self-supervised learning process based, at least in part, on the identifying, a neural network implementing an artificial intelligent model to provide a decision making for the specified driving scenario, wherein the artificial intelligence model is at least one of: a new artificial intelligence model, or one of the set of artificial intelligence models associated with the computerized system.

2. The method according to claim 1, further comprising determining whether any of the set of artificial intelligence models is within a confidence level to provide the decision making for the specified driving scenario, such that the training is in accordance with the determining.

3. The method according to claim 2, wherein the determining is by identifying a matching between the identified set of aerial image signatures and a corresponding set of signatures in association with any of the set of artificial intelligence models.

4. The method according to claim 2, wherein the determining is based on a maturity of any of the of the set of artificial intelligence models to perform the decision making process with respect to the specified driving scenario.

5. The method according to claim 1, wherein obtaining the aerial image signatures involves downloading the aerial image signatures at different points in time, in accordance with the driving scenario faced by the vehicle.

6. The method according to claim 1, wherein with the artificial intelligence model being a new artificial intelligence model, the method further comprises associating the computerized system with the new artificial intelligence model.

7. The method according to claim 1, wherein obtaining the aerial image signatures is in accordance with the specified driving scenario.

8. The method according to claim 1, further comprising predicting a subsequent artificial intelligence model for a decision making that follows the decision making of the determined artificial intelligence model.

9. The method according to claim 1, wherein the generating of the instructions involves triggering a responsive action with respect to the set of artificial intelligence models, based on the identifying and by using the aerial image signatures.

10. The method according to claim 1, further comprising generating instructions executable by the computerized system to trigger a notification indication to an autonomous driving application of the vehicle, based on the training.

11. A system of self-learning from air of AI models applicable for driving, the system comprising at least one processing device configured to:
obtain, by a computerized system, aerial image signatures of patches of aerial images that capture at least parts of an environment faced by a vehicle, wherein the computerized system is associated with a set of artificial intelligence models applicable for autonomous driving;
identify, from the aerial image signatures, a set of aerial image signatures in accordance with a specified driving scenario faced by the vehicle; and
train, in a self-supervised learning process based, at least in part, on the identified set of aerial image signatures, a neural network to implement an artificial intelligent model and to provide a decision making for the specified driving scenario, wherein the artificial intelligence model is at least one of: a new artificial intelligence model, or one of the set of artificial intelligence models associated with the computerized system.

12. A non-transitory computer readable medium storing instructions that, when executable by at least one processing device of a system, cause the system to:
obtain aerial image signatures of patches of aerial images that capture at least parts of an environment faced by a vehicle, wherein the computerized system is associated with a set of artificial intelligence models applicable for autonomous driving;
identify, from the aerial image signatures, a set of aerial image signatures in accordance with a specified driving scenario faced by the vehicle; and
train, in a self-supervised learning process based, at least in part, on the identified set of aerial image signatures, a neural network to implement an artificial intelligent model and to provide a decision making for the specified driving scenario, wherein the artificial intelligence model is at least one of: a new artificial intelligence model, or one of the set of artificial intelligence models associated with the computerized system.

13. The non-transitory computer readable medium according to claim 12, further storing instructions that, when executable by the least one processing device, cause the system to determine whether any of the set of artificial intelligence models is within a confidence level to provide the decision making for the specified driving scenario, such that the training is in accordance with the determining.

14. The non-transitory computer readable medium according to claim 13, wherein the determining is by identifying a matching between the identified set of aerial image signatures and a corresponding set of signatures in association with any of the set of artificial intelligence models.

15. The non-transitory computer readable medium according to claim 13, wherein the determining is based on a maturity of any of the of the set of artificial intelligence models to perform the decision making process with respect to the specified driving scenario.

16. The non-transitory computer readable medium according to claim 12, wherein obtaining the aerial image signatures involves downloading the aerial image signatures at different points in time, in accordance with the driving scenario faced by the vehicle.

17. The non-transitory computer readable medium according to claim 12, wherein with the artificial intelligence model being a new artificial intelligence model, the method further comprises associating the computerized system with the new artificial intelligence model.

18. The non-transitory computer readable medium according to claim 12, further storing instructions that, when executable by the least one processing device, cause the system to predict a subsequent artificial intelligence model for a decision making that follows the decision making of the determined artificial intelligence model.

19. The non-transitory computer readable medium according to claim 12, wherein the generating of the instructions involves triggering a responsive action with respect to the set of artificial intelligence models, based on the identifying and by using the aerial image signatures.

20. The non-transitory computer readable medium according to claim 12, further storing instructions that, when executable by the least one processing device, cause the system to trigger a notification indication to an autonomous driving application of the vehicle, based on the training.
